(19) United States
(12) Patent Application Publication
(10) Pub. No.: US 2020/0110209 A1
(43) Pub. Date: Apr. 9, 2020

(54) METHODS OF FORMING OPTICAL ARTICLES

(71) Applicant: Light Polymers Holding, Grand Cayman (KY)

(72) Inventors: Chih-Hao Huang, New Taipei City (TW); Valeriy Kuzmin, San Bruno, CA (US); Evgeny Morozov, Burlingame, CA (US)

(21) Appl. No.: 16/592,721

(22) Filed: Oct. 3, 2019

Related U.S. Application Data
(60) Provisional application No. 62/741,518, filed on Oct. 4, 2018.

(51) Int. Cl. G02B 5/30; G02B 1/08; B29D 11/00

(52) U.S. Cl. CPC G02B 5/3016; B29K 2995/0032; B29D 11/00644; G02B 1/08

(57) ABSTRACT

Methods of forming optical articles from lyotropic liquid crystal solutions are disclosed. A lyotropic liquid crystal solution is shear-coated on a temporary substrate to form a birefringent coating layer of 4 micrometers or less in thickness. A permanent substrate is adhered to the birefringent coating layer and the temporary substrate is removed. Optical articles formed by such methods are also disclosed.

### CROSS-REFERENCE

This application claims priority to U.S. Provisional Patent Application No. 62/741,518, filed Oct. 4, 2018, which is entirely incorporated herein by reference for all purposes.

### BACKGROUND

Films formed by shear-coating of lyotropic liquid crystals, such as polarizers and retarders, can be used in variety of applications. Quarter-wave retarder coatings and polarizer coatings of 4 micrometers or less, or 2 micrometers or less in thickness can be formed from lyotropic liquid crystals. In many applications, it is desired to obtain a coated film with overall thickness including that of the film substrate that are as thin as possible. However, it is often difficult to coat the lyotropic liquid crystals on substrate films that are quite thin (for example, less than 30 pm thick). Uniform coating cannot be achieved during roll-to-roll coating if the dimensional stability of substrate films is not sufficient.

When the wetting and affinity of a lyotropic liquid crystal coating formulation to a substrate surface is poor, the coating uniformity is negatively affected resulting in stripes and defects. Even if the substrate film has undergone corona treatment or plasma treatment or has been coated with a primer layer, there may still be problems with coating uniformity and manufacturing yields. Therefore, there are difficulties with coating lyotropic liquid crystals on certain substrates that are preferred for the final application.

### SUMMARY

In one aspect, a method of forming an optical article includes forming a birefringent coating layer on a coatable substrate that includes a temporary substrate, laminating a permanent substrate to the birefringent coating layer, and removing the temporary substrate from the birefringent coating layer.

The birefringent coating layer is formed by shear-coating a lyotropic liquid crystal solution and is 4 μm or less in thickness, or 2 μm or less in thickness. The lyotropic liquid crystal solution is shear-coated on the surface modification layer of the coatable substrate. The surface modification layer may be a primer layer or a hydrophilic layer, for example.

The coatable substrate may additionally include a release liner between the surface modification layer and the temporary substrate. After the permanent substrate is adhered to the birefringent coating layer, the temporary substrate can be removed. In cases where there is no release liner between the surface modification layer and the temporary substrate, the adhesion of the surface modification layer to the temporary substrate can be reduced by applying a heating roller to the temporary substrate, for example.

In another aspect, an optical article includes a birefringent coating layer which is 4 μm or less in thickness or 2 μm or less in thickness, a hydrophilic layer or a primer layer, and a main substrate. The birefringent coating layer is located between the main substrate and the hydrophilic layer or the primer layer, and the birefringent coating layer is adhered to the main substrate by an adhesive layer.

In another aspect, the birefringent coating layer is 1.0 micrometers or less in thickness and comprises a birefringent aromatic polymer, iodine anions, and multi-valent cations. In yet another aspect, the birefringent coating layer comprises a birefringent aromatic polymer, and the birefringent aromatic polymer comprises a group (SO₃⁻).

In yet another aspect, the optical article can be a linear polarizer or a retarder. A circular polarizer, a window film, a display, or eyewear can be made using the optical article.

The above summary of the present disclosure is not intended to describe each disclosed embodiment or every implementation of the claims. The description that follows more particularly exemplifies illustrative embodiments. In several places throughout the application, guidance is provided through examples, which examples can be used in various combinations. In each instance of a list, the recited list serves only as a representative group and should not be interpreted as an exclusive list.

### BRIEF DESCRIPTION OF THE FIGURES

The disclosure may be more completely understood in consideration of the following detailed description of various embodiments of the disclosure in connection with the accompanying drawings, in which:

FIG. 1 is a cross-sectional schematic diagram view of an illustrative coatable substrate according to a first embodiment.

FIG. 2 is a cross-sectional schematic diagram view of an illustrative coatable substrate upon which a lyotropic liquid crystal solution has been shear-coated, according to a first embodiment.

FIG. 3 is a cross-sectional schematic diagram view of an illustrative coated substrate, according to a first embodiment.

FIG. 4 is a cross-sectional schematic diagram view of an illustrative adhesive film.

FIG. 5 is a cross-sectional schematic diagram view of a permanent substrate with a release film.

FIG. 6 is a cross-sectional schematic diagram view of a permanent substrate without a release film.

FIG. 7 is a cross-sectional schematic diagram view of a permanent substrate laminated to a coated substrate, according to a first embodiment.

FIG. 8 is a cross-sectional schematic diagram view of an illustrative optical article, according to a first embodiment.

FIG. 9 is a cross-sectional schematic diagram view of an illustrative coatable substrate according to a second embodiment.

FIG. 10 is a cross-sectional schematic diagram view of an illustrative coatable substrate upon which a lyotropic liquid crystal solution has been shear-coated, according to a second embodiment.

FIG. 11 is a cross-sectional schematic diagram view of an illustrative coated substrate, according to a second embodiment.

FIG. 12 is a cross-sectional schematic diagram view of a permanent substrate laminated to a coated substrate, according to a second embodiment.

FIG. 13 is a cross-sectional schematic diagram view of an illustrative optical article, according to a second embodiment.

FIG. 14 is a schematic diagram of a method of forming an illustrative optical article.

FIG. 15 is a schematic diagram of a method of forming an illustrative permanent substrate.

FIG. 16 is a cross-sectional schematic diagram view of an illustrative coatable substrate, for explaining the third embodiment.

FIG. 17 is a cross-sectional schematic diagram view of an illustrative coatable substrate upon which a polymeric lyotropic liquid crystal solution has been shear-coated, according to a third embodiment.

FIG. 18 is a cross-sectional schematic diagram view of an illustrative coated substrate, according to a third embodiment.

FIG. 19 is a cross-sectional schematic diagram view of an illustrative coatable substrate upon which a multi-component lyotropic liquid crystal solution has been shear-coated, according to a fourth embodiment.

FIG. 20 is a cross-sectional schematic diagram view of an illustrative coated substrate, according to a fourth embodiment.

FIG. 21 is a schematic diagram of a method of forming an illustrative linear polarizer according to a third embodiment.

FIG. 22 is a schematic diagram of a method of forming an illustrative linear polarizer according to a fourth embodiment.

FIG. 23 is a graph of the wavelength dependence of the total transmittance (TT) and polarization efficiency (PE) of a polymeric birefringent coating layer, consisting of a birefringent aromatic polymer of structure (P1).

FIG. 24 is a graph of the wavelength dependence of the total transmittance (TT) and polarization efficiency (PE) of a linear polarizer layer, consisting of a birefringent aromatic polymer of structure (P1), according to the third embodiment.

FIG. 25 is a graph of the wavelength dependence of the dichroic ratio (Kd) of a linear polarizer layer, comprising a birefringent aromatic polymer of structure (P1), according to the third embodiment.

FIG. 26 is a graph of the wavelength dependence of the total transmittance (TT) and polarization efficiency (PE) of a linear polarizer layer, comprising a birefringent aromatic polymer of structure (P1), according to the fourth embodiment.

FIG. 27 is a graph of the wavelength dependence of the dichroic ratio (Kd) of a linear polarizer layer, comprising a birefringent aromatic polymer of structure (P1), according to the fourth embodiment.

FIG. 28 is a schematic top view of an illustrative linear polarizer.

FIG. 29 is a schematic top view of an illustrative retarder.

FIG. 30 is a schematic top view of an illustrative optical article.

FIG. 31 is a schematic side view of an illustrative optical article.

FIG. 32 is a graph of the wavelength dependence of the in-plane retardation of an illustrative retarder.

FIG. 33 is a schematic side view of another illustrative optical article.

### DETAILED DESCRIPTION OF ILLUSTRATIVE EMBODIMENTS

The present disclosure relates to a method of forming an optical article that includes a birefringent coating layer adhered to a permanent substrate. The birefringent coating layer is formed by shear-coating a lyotropic liquid crystal solution on a surface modification layer on a temporary substrate. After the formation of the birefringent coating layer, a permanent substrate is adhered to the birefringent coating layer and the temporary substrate is removed. The temporary substrate is selected for dimensional stability, ease of handling, and compatibility with the lyotropic liquid crystal solution and with the surface modification layer. The permanent substrate is selected for suitability to the final application.

Depending upon the lyotropic liquid crystal used, the birefringent coating layer can be a linear polarizer layer or a retarder layer. The retarder can be a quarter-wave retarder. The thickness of the birefringent coating layer is less than 4 micrometers, and in some cases less than 2 micrometer.

Lyotropic liquid crystal formulations may be coated onto a substrate to form a linear polarizer and preferably an achromatic linear polarizer. The lyotropic liquid crystal solution can be an aqueous solution. For forming a linear polarizer, the lyotropic liquid crystal solution can include two or more dichroic dye compounds. Alternatively, a lyotropic liquid crystal solution can include a birefringent aromatic polymer. In this case, a polymeric birefringent coating layer is formed by shear-coating the polymeric lyotropic liquid crystal solution, and the polymeric birefringent coating layer is converted into an iodized polymeric birefringent coating layer by staining in a doping-passivation solution.

In this disclosure:

“Aqueous” refers to a material being soluble or dissolved in water at an amount of at least 1 wt. % or at least 5 wt. % of the material in water at 20° C. and 1 atmosphere.

“Visible spectral range” refers to a spectral range between approximately 400 nm and 700 nm.

An optical coating being “substantially non-absorbing” at a certain wavelength means that its transmission of light at that wavelength is 90% or greater regardless of polarization state of the light, the transmission being normalized to the intensity of the light incident on the optical coating.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

The terms “comprises” and variations thereof do not have a limiting meaning where these terms appear in the description and claims.

Unless otherwise specified, “a,” “an,” “the,” and “at least one” are used interchangeably and mean one or more than one.

Also herein, the recitations of numerical ranges by endpoints include all numbers subsumed within that range (e.g., 1 to 5 includes 1, 1.5, 2, 2.75, 3, 3.80, 4, 5, etc.).

For any method disclosed herein that includes discrete steps, the steps may be conducted in any feasible order. And, as appropriate, any combination of two or more steps may be conducted simultaneously.

The substrate can be made of various materials, for example, glass, silicon, quartz, sapphire, plastic, and/or a polymer. The substrate can be in various forms, such as a film, a sheet, or a plate. Polymeric substrates can be, for example, cellulose triacetate (TAC); polyethylene terephthalate (PET), poly(methyl methacrylate) (PMMA), polycarbonate (PC), polyimide, or a cyclic-olefin polymer (COP). The substrate may be pre-treated before coating of the coatable liquid to improve adhesion of the coatable liquid and birefringent coating layer to the substrate. For example, the substrate may be corona treated, saponified, plasma treated, and/or treated with a primer layer or a hydrophilic layer. In some embodiments, the substrate is an optically functional substrate. “Optically functional substrate” refers to any substrate that has an optical function, such as focusing light, diffusing light, polarizing light, recycling light, filtering certain colors of the spectrum, controlling a phase shift between two orthogonal polarization components of light, and the like. Examples of optically functionally functional substrates include: prism film, diffuser film, brightness enhancement film, micro-lens film, color-filter array, lens, linear polarizer, circular polarizer, optical retarder (including quarter-wave plate and half-wave plate) and reflective polarizer. The birefringent coating layer can be adhered to the optically functional substrate.

Various combinations of birefringent coating layer and optically functional substrate (as the permanent substrate) are possible. A birefringent coating layer that functions as a linear polarizer can be combined with an optically functional substrate that functions as a quarter-wave plate (QWP) retarder. This combination functions as a circular polarizer, when the slow axes of the linear polarizer and the QWP are rotated by 45° from each other. Similarly, a birefringent coating layer that function as a QWP retarder can be combined with an optically functional substrate that functions as a linear polarizer, to form a circular polarizer. In this case, the linear polarizer-type optically functional substrate can be a PVA (polyvinyl alcohol) polarizer, for example. A birefringent coating layer that functions as a QWP retarder can be combined with an optically functional substrate that functions as a half-wave plate (HWP) retarder. This combination functions as a QWP retarder when the slow axes of the birefringent coating layer QWP and the optical element HWP are rotated by 90° from each other.

Various methods of coating the coatable liquid on the substrate are available. The coating method can be a batch process or an in-line process. In a batch process, substrates should be in the form of sheets or plates. Suitable coating methods in a batch process include spin coating, and spray coating. In an in-line process, the substrate should be a roll of film. Suitable coating methods in an in-line (roll-to-roll) process include slit coating, slot-die coating, micro-gravure coating, and comma coating.

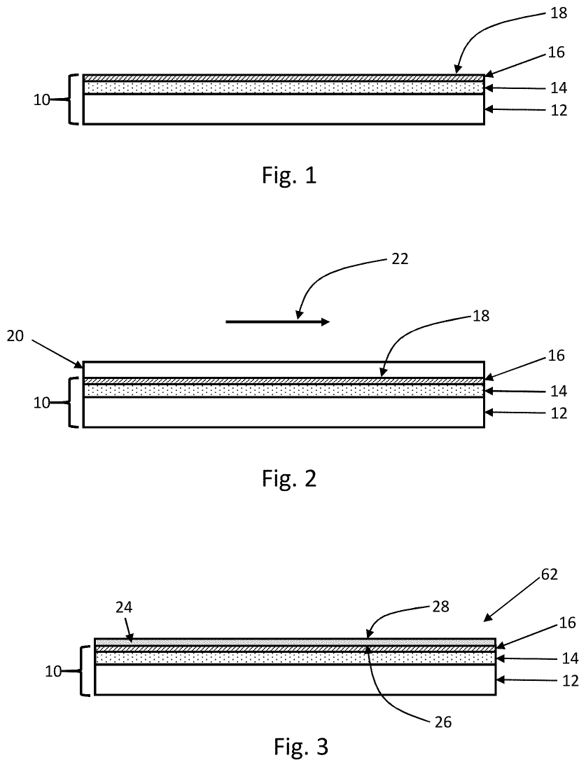

A method of forming an optical article according to a first embodiment is explained by referring to FIGS. 1-8 and FIGS. 14-15.

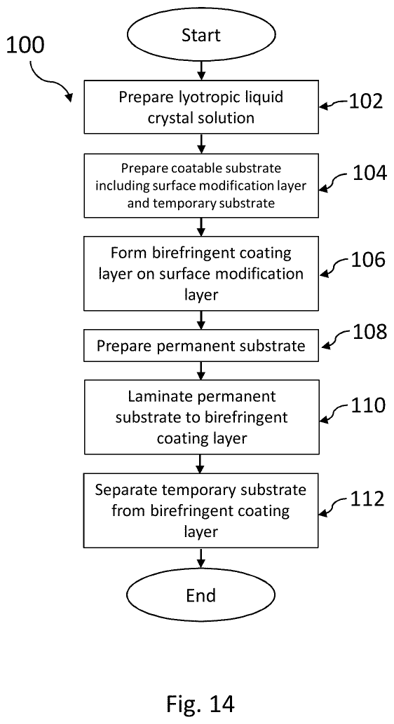

The steps in a method 100 of forming an illustrative optical article are shown in FIG. 14. At step 102, a lyotropic liquid crystal solution is prepared. Details of the lyotropic liquid crystal formulation and example constituent compounds are explained in the Examples below. At step 104, a coatable substrate is prepared. A coatable substrate 10 according to the first embodiment is shown schematically in FIG. 1. The coatable substrate 10 includes a temporary substrate 12, a release layer 14, and a hydrophilic layer 16, the three layers being positioned relative to each other such that the release layer 14 is between the temporary substrate 12 and the hydrophilic layer 16. An example of a temporary substrate is a polyethylene terephthalate (PET) film substrate. The PET film substrate may be 38 μm to 125 μm thick, for example. A PET film substrate is preferable because its cost is relatively low and has good mechanical stability. First, a release layer 14, approximately 400 nm to 500 nm thick, is coated on the temporary substrate 12. Second, a hydrophilic layer 16 is coated on the release layer 14. The exposed surface of the hydrophilic layer 16 is referred to as a coatable surface 18. The hydrophilic layer 16 is an example of a surface modification layer.

With continuing reference to FIG. 14, a birefringent coating layer is formed on the surface modification layer (step 106). The lyotropic liquid crystal solution, prepared at step 102, is shear-coated on the coatable surface 18 of the coatable substrate 10. The preparation of the birefringent coating layer according to the first embodiment is explained with reference to FIGS. 2 and 3. FIG. 2 is a cross-sectional schematic diagram view of the coatable substrate 10 upon which a lyotropic liquid crystal solution layer 20 has been formed by shear-coating along a shear-coating direction (arrow 22), according to the first embodiment. The step of shear-coating a lyotropic liquid crystal solution can be done by a suitable process, such as a slot die coating process. The lyotropic liquid crystal solution layer 20 is dried to form a birefringent coating layer 24 on the coatable substrate 10, as shown schematically in cross-section in FIG. 3. FIG. 3 is a cross-sectional schematic diagram view of a coated substrate 62, according to the first embodiment, which includes the birefringent coating layer 24 and the coatable substrate 10. The birefringent coating layer 24 has first and second major surfaces 26 and 28. First major surface 26 is in contact with the hydrophilic layer 16 (surface modification layer) of the coatable substrate 10. Second major surface 28 is opposite of first major surface 26. As shown in FIG. 3, second major surface 28 of the birefringent coating layer 24 is an exposed surface of the coated substrate 62.

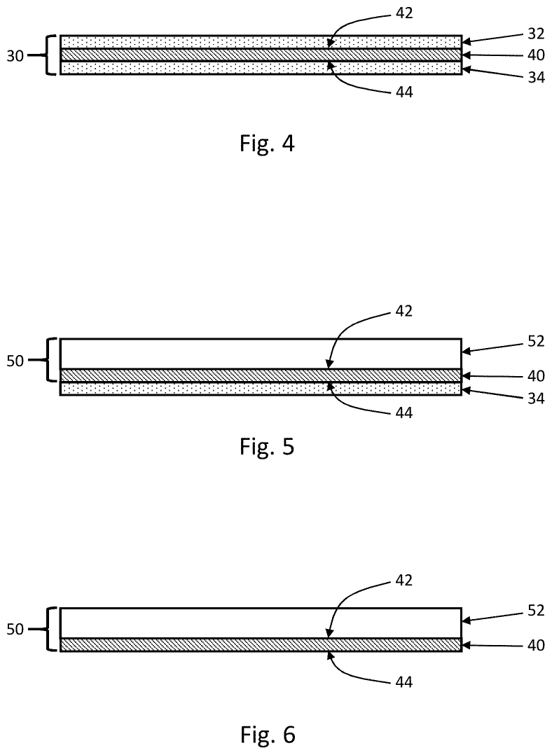

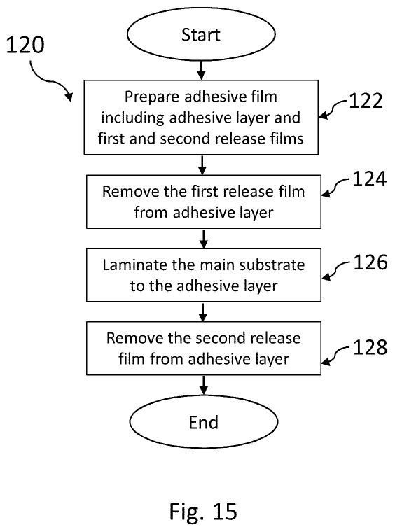

With continuing reference to FIG. 14, a permanent substrate is prepared, at step 108. The preparation of the permanent substrate is explained with reference to FIGS. 4-6 and 15. The steps in a method 120 of preparing a permanent substrate are shown in FIG. 15. FIG. 4 is a cross-sectional schematic diagram view of an adhesive film 30, which is a precursor to the permanent substrate (step 122 of FIG. 15). The adhesive film 30 includes a first release film 32, adhesive layer 40, and second release film 34, the three layers being positioned relative to each other such that the adhesive layer 40 is between the first release film 32 and the second release film 34. The adhesive layer 40 has third and fourth major surfaces 42 and 44. The first release film 32 is adhered to third major surface 42 and the second release film 34 is adhered to the fourth major surface 44. For example, the adhesive layer 40 is a 10 μm thick OCA (optically clear adhesive) layer, and the first release film 32 and the second release film 34 are each PET films 50 to 100 μm thick.

The first release film 32 is removed from the adhesive layer 40, thereby exposing the third major surface 42 (step 124). Then, a permanent main substrate 52 is affixed to the third major surface 42 of the adhesive layer 40 (step 126). For example, the permanent main substrate may be a 180 μm thick polycarbonate (PC) substrate or a 33 μm thick cyclic-olefin polymer (COP) substrate. The result is shown in FIG. 5. FIG. 5 is a cross-sectional schematic diagram view of a permanent substrate 50 with a release film (second release film 34), which is the result of replacing one of the release films (first release film 32) with the permanent main substrate 52. After the permanent substrate 52 has been adhered to the adhesive layer 40, the remaining release film (the second release film 34) is removed from the adhesive layer 40 (step 128). FIG. 6 is a cross-sectional schematic diagram view of a permanent substrate 50 after removal of the second release film 34, at step 128. At this time, the fourth major surface 44 of the adhesive layer 40 is exposed.

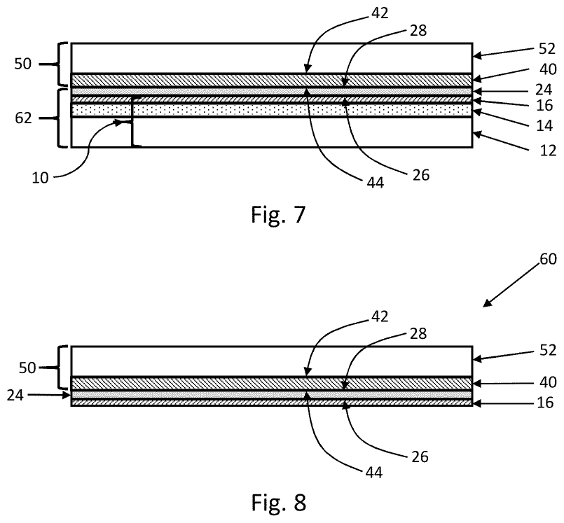

With continuing reference to FIG. 14, the permanent substrate 50 (main substrate 52 and adhesive layer 40) are laminated to the birefringent coating layer 24, at step 110. As shown in FIG. 7, the fourth major surface 44 of the adhesive layer 40 is brought into contact with the second major surface 28 of the birefringent coating layer 24. FIG. 7 is a cross-sectional schematic diagram view of a permanent substrate 50 laminated to a coated substrate 62, according to a first embodiment. FIG. 7 shows a result upon completion of step 110.

At step 112, the temporary substrate 12 is separated from the birefringent coating layer 24. The separation occurs at the release layer 14 which is located between the temporary substrate 12 and the birefringent coating layer 24. During the separation, at least some of the hydrophilic molecules in the hydrophilic layer 16 stay adhered to the birefringent coating layer 24. FIG. 8 shows a result upon completion of step 110. FIG. 8 is a cross-sectional schematic diagram view of an illustrative optical article, according to a first embodiment.

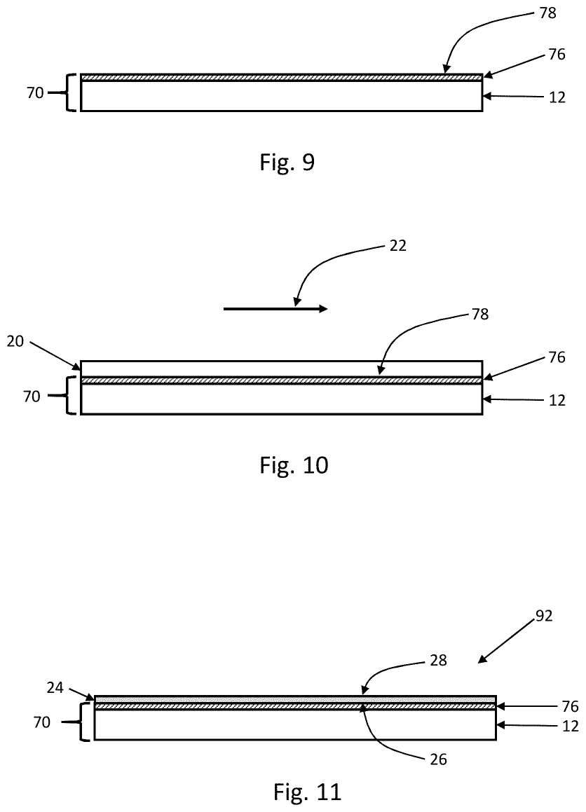

A method of forming an optical article according to a second embodiment is explained by referring to FIGS. 9-15. The second embodiment differs from the first embodiment in that the coatable substrate does not have a release layer. As in the first embodiment, the steps in a method 100 of forming an illustrative optical article are shown in FIG. 14, and the steps in a method 120 of preparing a permanent substrate are shown in FIG. 15. At step 104, a coatable substrate is prepared. A coatable substrate 70 according to the second embodiment is shown schematically in FIG. 9. The coatable substrate 70 includes a temporary substrate 12 and a primer layer 76. An example of a temporary substrate is a polyethylene terephthalate (PET) film substrate. The PET film substrate may be 38 μm to 125 μm thick, for example. A primer layer 76 is coated on the temporary substrate 12. The exposed surface of the primer layer 76 is referred to as a coatable surface 78. The primer layer 76 is an example of a surface modification layer.

At step 106, a birefringent coating layer is formed on the surface modification layer. The lyotropic liquid crystal solution, prepared at step 102, is shear-coated on the coatable surface 78 of the coatable substrate 70. The preparation of the birefringent coating layer according to the second embodiment is explained with reference to FIGS. 10 and 11. FIG. 10 is a cross-sectional schematic diagram view of the coatable substrate 70 upon which a lyotropic liquid crystal solution layer 20 has been formed by shear-coating along a shear-coating direction (arrow 22), according to the second embodiment. The step of shear-coating a lyotropic liquid crystal solution can be done by a suitable process, such as a slot die coating process. The lyotropic liquid crystal solution layer 20 is dried to form a birefringent coating layer 24 on the coatable substrate 70, as shown schematically in cross-section in FIG. 11. FIG. 11 is a cross-sectional schematic diagram view of a coated substrate 92, according to the second embodiment, which includes the birefringent coating layer 24 and the coatable substrate 70. The birefringent coating layer 24 has first and second major surfaces 26 and 28. First major surface 26 is in contact with the primer layer 76 (surface modification layer) of the coatable substrate 70. Second major surface 28 is opposite of first major surface 26. As shown in FIG. 11, second major surface 28 of the birefringent coating layer 24 is an exposed surface of the coated substrate 92.

At step 108, a permanent substrate is prepared. The preparation of the permanent substrate has been explained with reference to FIGS. 4-6 and 15, and is identical to the first embodiment.

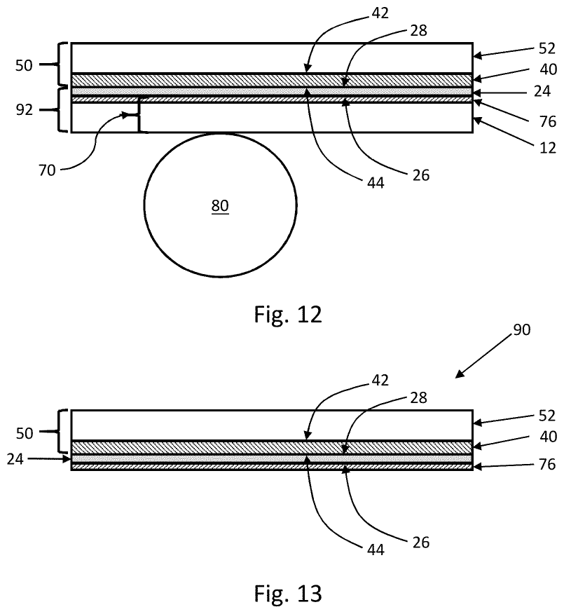

At step 110, the permanent substrate 50 (main substrate 52 and adhesive layer 40) are laminated to the birefringent coating layer 24. As shown in FIG. 12, the fourth major surface 44 of the adhesive layer 40 is brought into contact with the second major surface 28 of the birefringent coating layer 24. FIG. 12 is a cross-sectional schematic diagram view of a permanent substrate 50 laminated to a coated substrate 92, according to a second embodiment. FIG. 12 shows a result upon completion of step 110.

In the second embodiment, the coated substrate 92 does not include a release layer. Therefore, the adhesion of the birefringent coating layer 24 to the temporary substrate 12 should be weakened, before separating the temporary substrate 12 from the birefringent coating layer 24. This can be done by contacting a heating roller 80 of a lamination machine to the temporary substrate side (shown schematically in FIG. 12). For example, the heating roller 80 is at a temperature between 50° C. and 80° C. during the step of contacting the heating roller 80 to the temporary substrate 12, with a lamination speed of 0.5 to 2.0 meters/minute. In one example, the heating roller 80 is contacted to the temporary substrate side during the lamination of the permanent substrate 50 to the birefringent coating layer 24 (step 110).

At step 112, the temporary substrate 12 is separated from the birefringent coating layer 24. During the separation, at least some of the hydrophilic molecules in the primer layer 76 stay adhered to the birefringent coating layer 24. FIG. 13 shows a result upon completion of step 112. FIG. 13 is a cross-sectional schematic diagram view of an illustrative optical article, according to a second embodiment.

The third and fourth embodiments relate specifically to birefringent coating layers of the polymeric type, or polymeric birefringent coating layers. For ease of discussion, the third and fourth embodiments are described with respect to a generic coatable substrate. However, the polymeric birefringent coating layers according to the third embodiment or the fourth embodiment can also be used in forming optical articles according to the first and second embodiments. The polymeric birefringent coating layers can be made into retarders or linear polarizers, as detailed below.

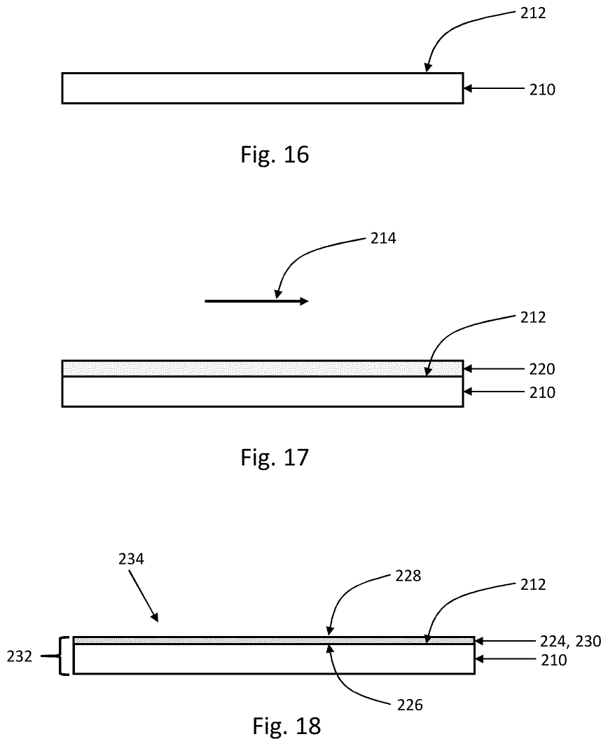

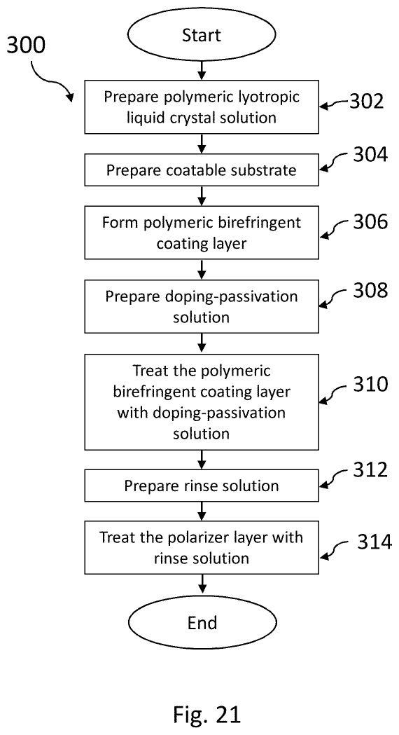

A method 300 of forming an illustrative linear polarizer according to the third embodiment is shown in FIG. 21. At step 302, a polymeric lyotropic liquid crystal solution is prepared. The polymeric lyotropic liquid crystal solution includes an aqueous solution of a birefringent aromatic polymer. Details of the polymeric lyotropic liquid crystal solutions are explained below. At step 304, a coatable substrate is prepared. A coatable substrate 210 is shown schematically in FIG. 16. The coatable substrate 210 includes a coatable surface 212. An example of a coatable substrate is a glass substrate. Another example of a coatable substrate is a TAC film substrate. Other examples of coatable substrates are coatable substrate 10 (FIG. 1, first embodiment) and coatable substrate 70 (FIG. 9, second embodiment). For example, step 304 may include cleaning the substrate to reduce particles, and/or coating the substrate with a primer layer or a hydrophilic layer.

With continuing reference to FIG. 21, a polymeric birefringent coating layer is formed on the coatable substrate (step 306). The polymeric lyotropic liquid crystal solution, prepared at step 302, is shear-coated on the coatable surface 212 of the coatable substrate 210. The preparation of the polymeric birefringent coating layer according to the third embodiment is explained with reference to FIGS. 17 and 18. FIG. 17 is a cross-sectional schematic diagram view of the coatable substrate 210 upon which a polymeric lyotropic liquid crystal solution layer 220 has been formed by shear-coating along a shear-coating direction (arrow 214), according to the third embodiment. The step of shear-coating a polymeric lyotropic liquid crystal solution can be done by a suitable process, such as a slit coating, a slot-die coating, micro-gravure coating, and comma coating. The polymeric lyotropic liquid crystal solution layer 220 is dried to form a polymeric birefringent coating layer 224 on the coatable substrate 210, as shown schematically in cross-section in FIG. 18. FIG. 18 is a cross-sectional schematic diagram view of a coated substrate 232 according to the third embodiment, which includes the polymeric birefringent coating layer 224 and the coatable substrate 210. The polymeric birefringent coating layer 224 has two major surfaces 226 and 228. Inner major surface 226 is in contact with the coatable surface 212 of the coatable substrate 210. Outer major surface 228 is opposite of coating layer inner major surface 226, and is shown as being exposed in FIG. 18. The polymeric birefringent coating layer is preferably 2.0 micrometers or less in thickness, and more preferably 1.0 micrometers or less in thickness.

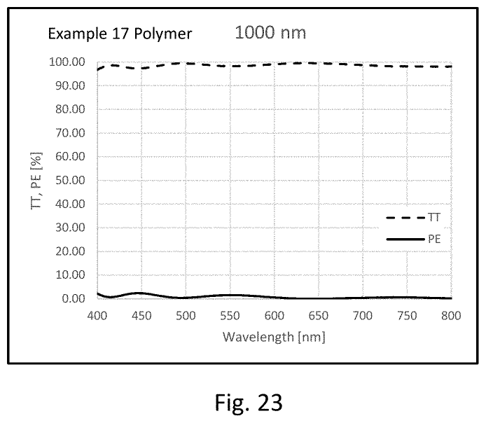

Optical properties of the coated substrate 232 including the polymeric birefringent coating layer 224 and the coatable substrate 210 were measured for an example coated substrate. The Example 17 Polymer lyotropic liquid crystal solution was shear-coated to form a coating layer, approximately 1000 nm thick, on a glass substrate. FIG. 23 is a graph of the wavelength dependence of the total transmittance (TT) and polarization efficiency (PE) of this coating layer. For this coating layer, the total transmission (TT) was at least 90% in the visible spectral range, or in other words the coating layer is substantially non-absorbing in the visible spectral range. The coating layer exhibits polarization efficiencies (PE) of less than 3% in the visible spectral range. The polymeric birefringent coating layers exhibit negligible polarization in the visible spectral range before they are treated with a doping-passivation solution.

With continuing reference to FIG. 21, a doping-passivation solution is prepared (step 308), and then the polymeric birefringent coating layer is treated with the doping-passivation solution (step 310). The doping-passivation solution is a solution containing doping constituents and multi-valent cations. The doping constituents are iodine (12) and iodide salts and cause the polymeric birefringent coating layer to become doped with iodine anions (I₃⁻ and I₅⁻, for example). The doping constituents are dissolved in aqueous solution. Examples of iodide salts are: KI, NH₄I, LiI, NaI, CsI, ZnI₂, AlI₃, and SrI₂. These iodide salts, upon dissolution, yield the following cations respectively: K⁺, NH₄⁺, Li⁺, Na⁺, Cs⁺, Zn²⁺, Al³⁺, and Sr²⁺. Upon doping with iodine anions, the polymeric birefringent coating layer exhibits polarization. The multi-valent cations render the polymeric birefringent coating layer insoluble in water, by an ion exchange process. In this ion exchange process, monovalent ions of the birefringent aromatic polymers are exchanged for divalent or trivalent cations (multi-valent cations). In this case, examples of multi-valent cations are: Ba²⁺, Mg²⁺, Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Co²⁺, and Sn²⁺. Therefore, after the ion exchange, the coating layer would contain one or more of the aforementioned multi-valent cations. In preparing the doping-passivation solution, multi-valent cations are obtained by dissolving certain salts and/or compounds in solution. Some examples of these salts or compounds are: Cr₂(SO₄)₃, BaCl₂, Mg(CH₃COO)₂, SrCl₂, AlCl₃, FeSO₄, Cu(CH₃COO)₂, Zn(CH₃COO)₂, ZnI₂, ZnBr₂, ZnSO₄, ZnCl₂, Ni(CH₃COO)₂, and Co(CH₃COO)₂. At step 310, the polymeric birefringent coating layer is treated with the doping-passivation solution. For example, step 310 may include dip-coating the coated substrate 232 in the doping-passivation solution. Alternatively, step 310 may include imprinting, spray coating, ink jet printing, or flexo-printing. The polymeric birefringent coating layer 224, which is was substantially non-absorbing in the visible spectral range, is transformed into a linear polarizer layer 230 having high polarization efficiency in the visible spectral range.

Next, it is preferable to remove excess doping-passivation solution from the linear polarizer layer 230. This can be carried out by spin-drying the coated substrate 232. Alternatively, the coated substrate 232 can be treated with a rinse solution and then dried. This case is illustrated in FIG. 21. A rinse solution is prepared (step 312), and then the doped polymeric birefringent coating layer is treated with the rinse solution (step 314). For example, the rinse solution is a solution of denatured ethanol containing approximately 5% water. For example, step 314 may include submerging the coated substrate 232 in the rinse solution. After rinsing the coated substrate 232 is dried. It has been found that the step of treating the linear polarizer layer with the rinse solution helps to improve the properties of the linear polarizer layer. This completes the steps in forming a linear polarizer 234.

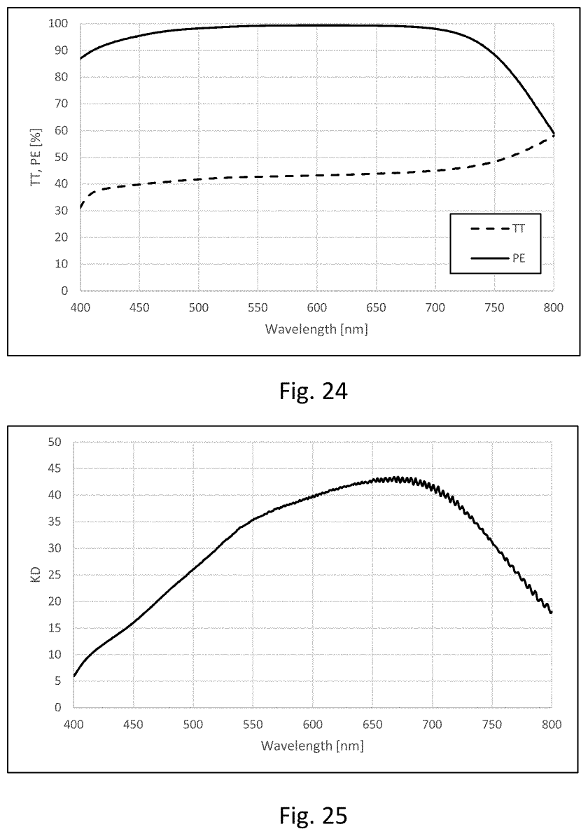

Optical properties of the linear polarizer layer 230 were measured for a linear polarizer layer according to the third embodiment, formed from a 0.8 μm thick Example 17 Polymer coating and treated with a doping-passivation solution, and rinsed, according to details provided in Example 19 (Example 19 Sample). FIG. 24 is a graph of the wavelength dependence of the total transmittance (TT) and polarization efficiency (PE) of the Example 19 Sample. FIG. 25 is a graph of the wavelength dependence of the dichroic ratio (Kd) of the Example 19 Sample. At 550 nm, TT=42.72%, PE=99.21%, and Kd=35.31. Averaged over the spectral range of 400 nm-700 nm, TT=42.0%, PE=97.6%, and Kd=30.9. The maximum Kd, which occurs around 668 nm, is 43.43.

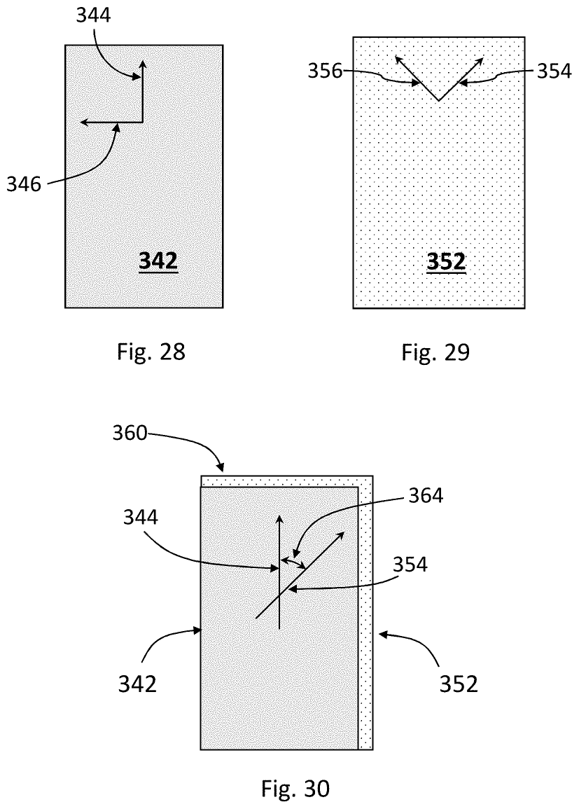

The quantities TT (total transmittance), PE (polarization efficiency), and Kd (dichroic ratio) are explained with reference to FIG. 28. FIG. 28 is a top schematic view of an illustrative linear polarizer layer 342. A polymeric lyotropic liquid crystal solution which contains a birefringent aromatic polymer has been shear-coated along an in-plane direction 344. As a result of the shear-coating, the birefringent aromatic polymer is generally aligned along direction 344. Direction 344 would be equivalent to direction 214 in FIG. 17. FIG. 28 shows two in-plane directions: direction 344, along which optical absorption would be approximately maximum (transmission approximately minimum), and direction 346, orthogonal to direction 344, along which optical absorption would be approximately minimum (transmission approximately maximum). Linear polarizer transmittance for polarization along direction 344 is referred to as Tₘᵢₙ and linear polarizer transmittance for polarization along direction 346 is referred to as Tₘₐₓ. Total transmittance is calculated as TT=½(Tₘᵢₙ+Tₘₐₓ), polarization efficiency is calculated as PE=(Tₘₐₓ−Tₘᵢₙ)/(Tₘₐₓ+Tₘᵢₙ), and dichroic ratio is calculated as Kd=ln Tₘᵢₙ/ln Tₘₐₓ.

FIG. 21 is a flow diagram of a method 300 of forming an illustrative linear polarizer according to the third embodiment. Steps 306, 308, 310, 312, and 314 of method 300 can be incorporated as sub-steps of step 106 of method 100 (FIG. 14).

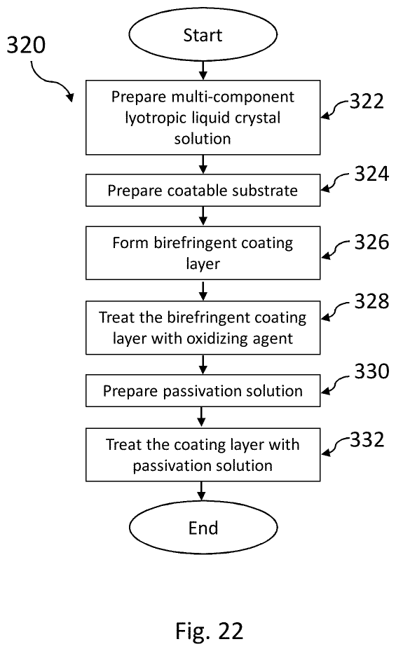

A method 320 of forming an illustrative linear polarizer according to the fourth embodiment is shown in FIG. 22. At step 322, an multi-component lyotropic liquid crystal solution is prepared. This multi-component lyotropic liquid crystal solution is similar to the polymeric lyotropic liquid crystal solution of the third embodiment (FIG. 21, step 302) in that it includes a birefringent aromatic polymer and water. The multi-component lyotropic liquid crystal solution also includes other components: an iodide salt and carbamide, also called urea. Examples of iodide salts are: KI, NH₄I, LiI, NaI, CsI, ZnI₂, AlI₃, and SrI₂. These iodide salts, upon dissolution, yield the following cations respectively: K⁺, NH₄⁺, Li⁺, Na⁺, Cs⁺, Zn²⁺, Al³⁺, and Sr²⁺. Details of the multi-component lyotropic liquid crystal solutions are explained below. At step 324, a coatable substrate is prepared. The coatable substrate 210 was explained with reference to FIG. 16.

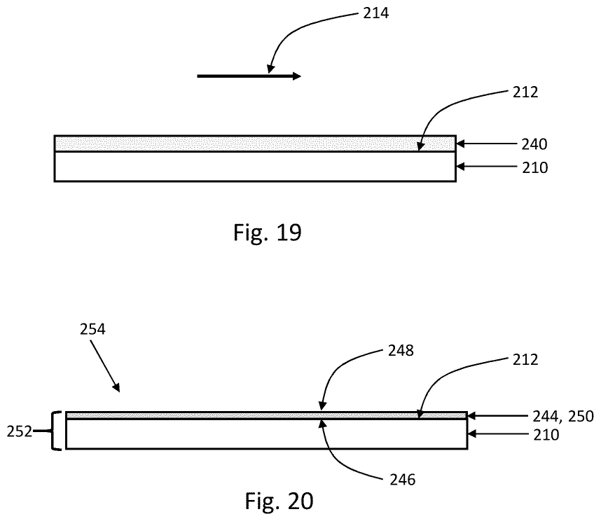

With continuing reference to FIG. 22, a birefringent coating layer is formed on the coatable substrate (step 326). The multi-component lyotropic liquid crystal solution, prepared at step 322, is shear-coated on the coatable surface 212 of the coatable substrate 210. The preparation of the birefringent coating layer according to the fourth embodiment is explained with reference to FIGS. 19 and 20. FIG. 19 is a cross-sectional schematic diagram view of the coatable substrate 210 upon which a multi-component lyotropic liquid crystal solution layer 240 has been formed by shear-coating along a shear-coating direction (arrow 214), according to the fourth embodiment. The multi-component lyotropic liquid crystal solution layer 240 is dried to form a birefringent coating layer 244 on the coatable substrate 210, as shown schematically in cross-section in FIG. 20. FIG. 20 is a cross-sectional schematic diagram view of a coated substrate 252 according to the fourth embodiment, which includes the birefringent coating layer 244 and the coatable substrate 210. The birefringent coating layer 244 has two major surfaces 246 and 248. Inner major surface 246 is in contact with the coatable surface 212 of the coatable substrate 210. Outer major surface 248 is opposite of coating layer inner major surface 246, and is shown as being exposed in FIG. 20.

With continuing reference to FIG. 22, the birefringent coating layer is treated with an oxidizing agent (step 328). The birefringent coating layer 244, which is substantially non-polarizing in the visible spectral range, is transformed into a linear polarizer layer 250 having high polarization efficiency in the visible spectral range. At this step, iodine ions from iodide salts are activated in the presence of carbamide and an oxidizing agent. It has been found that ozone is effective as an oxidizing agent. For example, the birefringent coating layer is treated with ozone generated by an ozone generator or corona treater. Upon completion of the ozone treatment, coated substrate 252 functions as a linear polarizer 254. Steps 330 and 332 are optional steps for rendering the linear polarizer layer water-insoluble. At step 330, a passivation solution is prepared, and then coating layer is treated with the passivation solution (step 332). The passivation solution contains multi-valent cations. The multi-valent cations render the coating layer insoluble in water, by an ion exchange process. In this ion exchange process, monovalent ions of the birefringent aromatic polymers are exchanged for divalent or trivalent cations (multi-valent cations). In this case, examples of multi-valent cations are: Ba²⁺, Mg²⁺, Sr²⁺, Al³⁺, La³⁺, Ce³⁺, Fe³⁺, Cr³⁺, Mn²⁺, Cu²⁺, Zn²⁺, Pb²⁺, Ca²⁺, Ni²⁺, Co²⁺, and Sn²⁺. Therefore, after the ion exchange, the coating layer would contain one or more of the aforementioned multi-valent cations. In preparing the passivation solution, multi-valent cations are obtained by dissolving certain salts and/or compounds in solution. Some examples of these salts or compounds are: Cr₂(SO₄)₃, BaCl₂, Mg(CH₃COO)₂, SrCl₂, AlCl₃, FeSO₄, Cu(CH₃COO)₂, Zn(CH₃COO)₂, ZnI₂, ZnBr₂, ZnSO₄, ZnCl₂, Ni(CH₃COO)₂, and Co(CH₃COO)₂. At step 332, the coating layer is treated with the passivation solution. For example, step 332 may include dip-coating the coated substrate 252 in the passivation solution.

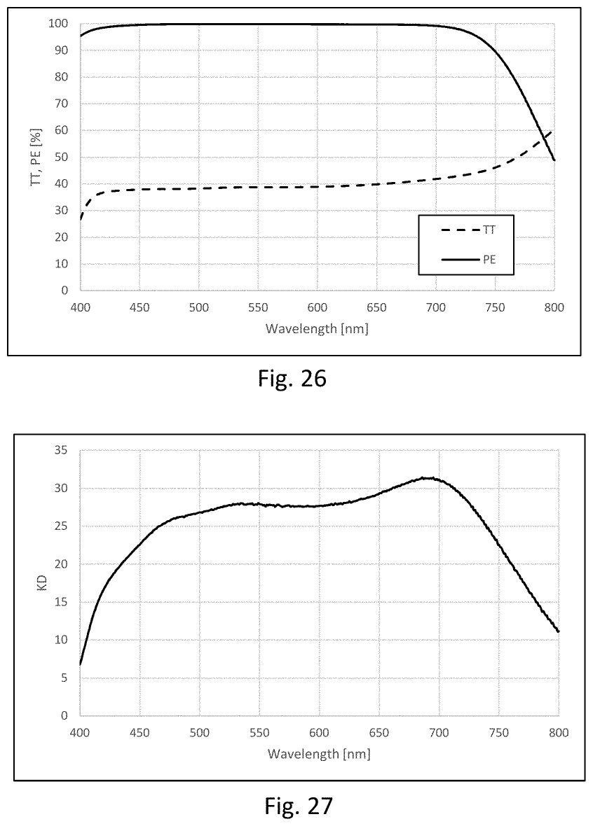

Optical properties of the linear polarizer layer 250 were measured for a linear polarizer layer according to the fourth embodiment, formed from a 1.5 μm thick, multi-component birefringent coating including the Example 17 Polymer and treated with ozone using a corona treater, according to details provided in Example 20 (Example 20 Sample). FIG. 26 is a graph of the wavelength dependence of the total transmittance (TT) and polarization efficiency (PE) of the Example 20 Sample. FIG. 27 is a graph of the wavelength dependence of the dichroic ratio (Kd) of the Example 20 Sample. At 550 nm, TT=38.76%, PE=99.79%, and Kd=27.90. Averaged over the spectral range of 400 nm-700 nm, TT=38.6%, PE=99.5%, and Kd=26.1. The maximum Kd, which occurs around 686 nm, is 31.43. A linear polarizer layer according to either of the embodiments can be used as a linear polarizer in a display such as a liquid crystal display.

FIG. 22 is a flow diagram of a method 320 of forming an illustrative linear polarizer according to the fourth embodiment. Steps 326, 328, 330, and 332 of method 320 can be incorporated as sub-steps of step 106 of method 100 (FIG. 14).

A polymeric birefringent coating layer obtained using the Example 17 Polymer is substantially non-absorbing in the visible spectral range (400 nm-700 nm) (FIG. 23). As a result of the shear-coating, a polymeric birefringent coating layer exhibits in-plane optical retardation. A polymeric birefringent coating layer, that has not been treated as a doping-passivation solution, can be configured as an optical retarder. FIG. 29 is a top schematic view of an illustrative retarder layer 352. A polymeric lyotropic liquid crystal solution which contains a birefringent aromatic polymer has been shear-coated along an in-plane direction 354. As a result of the shear-coating, the birefringent aromatic polymer is generally aligned along direction 354. Direction 354 would be equivalent to direction 214 in FIG. 17. FIG. 29 shows two in-plane directions: direction 354, along which the refractive index at a certain wavelength in the visible wavelength range would be approximately maximum, and direction 356, orthogonal to direction 354, along which the refractive index at that certain wavelength would be approximately minimum. The refractive index at a wavelength along direction 354 is referred to as nₓ(λ), and the refractive index at the wavelength λ along direction 356 is referred to as n_{y}(λ). The in-plane retardation Rₒ(λ) is defined as Rₒ(λ)=(nₓ(λ)−n_{y}(λ))·d, where d is the thickness of the layer exhibiting in-plane retardation, namely the polymeric birefringent coating layer. The polymeric birefringent coating layer has this birefringent property, namely the in-plane retardation, even though the layer has not been stretched. The birefringence arises from the shear force applied to the lyotropic liquid crystal during the coating. For comparison, films of ordinary polymers such as polyvinyl alcohol (PVA), cyclic-olefin polymer (COP), and polyethylene exhibit birefringence only when stretched.

FIG. 32 is a graph of the wavelength dependence of the in-plane retardation Rₒ(λ) of an illustrative retarder layer. The polymeric birefringent coating layer was formed by shear-coating a lyotropic liquid crystal solution containing the Example 17 polymer in aqueous solution, at a concentration of approximately 16 wt %. The thickness of the polymeric birefringent coating layer was approximately 750 nm. The retardation data were measured with a polarimeter Axometrics Axoscan. At a wavelength of 550 nm, the in-plane retardation shown in FIG. 32 is approximately 136.2 nm, which is approximately equal to the perfect quarter-wave retardation of 137.5 nm at a wavelength of 550 nm. For some applications described hereinbelow, an optical retarder can be considered to be a quarter-wave retarder if it exhibits an in-plane retardation in a range of 110 nm to 175 nm at wavelength of 550 nm, or more preferably in a range of 130 nm to 145 nm at a wavelength of 550 nm.

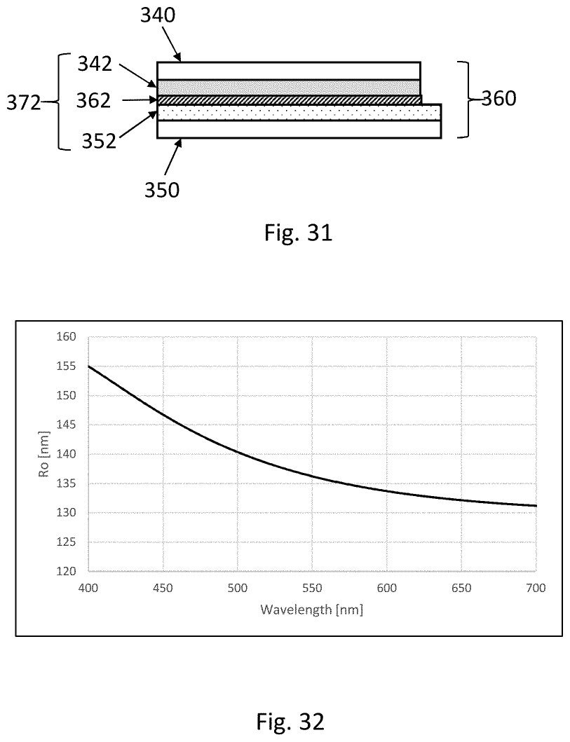

A circular polarizer can be formed from a suitable combination of linear polarizer layer and a quarter-wave retarder layer. FIGS. 30 and 31 are schematic top and side views of an illustrative optical article 360. Optical article 360 includes: a linear polarizer layer 342, a retarder layer 352, optionally a substrate 340 on which the linear polarizer layer 342 was formed, and optionally a substrate 350 on which the linear polarizer layer 352 was formed. As discussed, the linear polarizer layer is preferably 1.0 micrometers or less in thickness, and the retarder layer is preferably 1.0 micrometers or less in thickness. The retarder layer can be configured as a quarter-wave retarder, preferably exhibiting an in-plane retardation in a range of 110 nm to 175 nm at wavelength of 550 nm, or more preferably exhibiting an in-plane retardation in a range of 130 nm to 145 nm at a wavelength of 550 nm. Linear polarizer layer 342 and retarder layer 352 overlap to form a stack. The optical retarder layer 352 includes a first birefringent aromatic polymer generally aligned along a direction 354 (shear-coating direction of the first birefringent aromatic polymer), and the linear polarizer layer 342 includes a second birefringent aromatic polymer generally aligned along a direction 344 (shear-coating direction of the second birefringent aromatic polymer). In order to obtain a circular polarizer, the retarder layer 352 and the linear polarizer 342 are oriented relative to each other such that an angle 364 between the two alignment directions 354, 344 is in a range of 40° to 50°, and preferably in a range of 43° to 47°. In the case of an ideal quarter-wave retarder, the angle 364 would ideally be 45°.

The optical article 360 additionally includes an intermediate layer 362 interposed between the retarder layer 352 and the linear polarizer layer 342. The intermediate layer limits ion diffusion between the linear polarizer layer 342 and the optical retarder layer 352. The intermediate layer is preferably 100 μm in thickness or less. For example, the intermediate layer 362 acts as a barrier for the diffusion of iodine anions from the linear polarizer layer 342 to the optical retarder layer 352. Additionally, the intermediate layer 362 can include an adhesive, such as an acrylic optically clear adhesive (OCA). In this case, the intermediate layer can be used to laminate the linear polarizer (consisting of the linear polarizer layer 142 on substrate 140) and the retarder (consisting of the retarder layer 352 on substrate 350) together. The overlapped stack of the retarder layer 352, the linear polarizer layer 342, and the intermediate layer 362 interposed between them can be referred to as a circular polarizer 372 when the retarder is configured as a quarter-wave retarder and the retarder layer 352 and the linear polarizer layer 342 are oriented relative to each other at the angle 364 as described above.

The concepts of optical article 360 (FIG. 21) can be applied to the optical article 60 of the first embodiment (FIG. 8) and/or the optical article 90 of the second embodiment (FIG. 13). The birefringent coating layer 24 can be a linear polarizer layer (analogous to linear polarizer layer 342). The adhesive layer 40 can be the intermediate layer 362. The main substrate can be an optically functional substrate. For example, the main substrate is configured as a retarder, or more particularly a quarter-wave plate (QWP) retarder. In the case that the main substrate is configured as a QWP retarder, a circular polarizer can be obtained. There are several possible variations for the main substrate. The main substrate could be a polymer film (for example, a COP film) that has undergone stretching to yield an in-plane retardation value that approximates a QWP retarder. Alternatively, the main substrate can include the following combination: a birefringent coating layer that functions as a QWP retarder coated on an optically functional substrate that functions as a half-wave plate (HWP) retarder. A polymer film (for example, a COP film) that has undergone stretching to yield an in-plane retardation value that approximates a HWP retarder can be used as the optically functional substrate. This combination functions as a QWP retarder when the slow axes of the birefringent coating layer QWP and the optical element HWP are rotated by 90° from each other. This combination is described in Example 12. Alternatively, the main substrate can include the following combination: one or more birefringent coating layers, together functioning as a QWP retarder, coated on an optically isotropic substrate (a substrate that exhibits negligible birefringence).

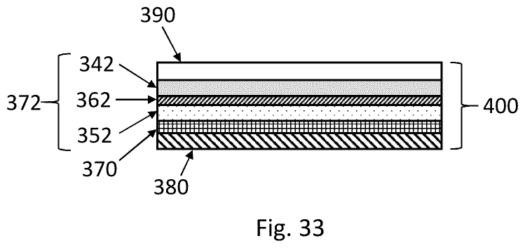

FIG. 33 is a schematic side view of another illustrative optical article 400. Optical article 400 includes an overlapped stack of the following items, ordered by proximity to a viewer: an outer substrate 390 (closest to viewer), a linear polarizer layer 342, an intermediate layer 362 interposed between the linear polarizer layer 342 and the retarder 352, a retarder layer 352, a touch sensor layer 370, and an organic light-emitting diode (OLED) display panel 380 (farthest from viewer). The circular polarizer stack 372 consisting of the linear polarizer layer 342, intermediate layer 362, and the retarder layer 352, is as described above. OLED display panel 380 is configured to emit light toward the circular polarizer 372. A circular polarizer (372) positioned in front of the OLED display panel 380 can reduce reflection of ambient light (light entering from the ambient into optical article 400 through outer substrate 390 towards OLED display panel 380) from the OLED display panel 380 back toward the viewer. In the case of optical article 400, the retarder layer 352, the intermediate layer 362, and the linear polarizer 342, can be sequentially formed on top of an existing panel or substrate consisting of an OLED display and a touch sensor layer.

Lyotropic Liquid Crystals—Dye Compounds

The lyotropic liquid crystal formulations used herein to make a linear polarizer include two or more dichroic dye compounds such as the blue dichroic dye compounds, red dichroic dye compounds, and violet dichroic dye compounds, as described herein.

Blue dichroic dye compounds include compounds having structure B (shown below):

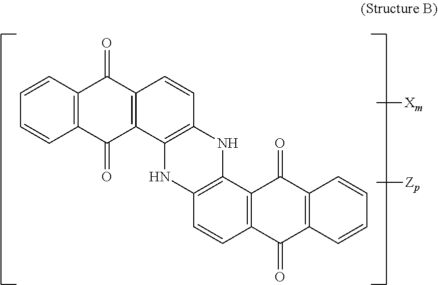

wherein:
X is a SO₃H (sulfonic) group or a salt thereof, and 1≤m≤4;
Z is a Cl (chloro) group, and 0≤p≤2; and
m+p≤4.

In the case that X (of Structure B) is a salt, the cation can be: Na⁺, K⁺, Cs⁺, or NH₄⁺.

Red dichroic dye compounds include compounds having structure R (shown below):

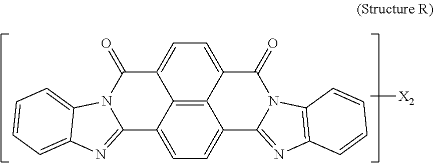

or a trans-isomer of structure R, wherein, X is a SO₃H (sulfonic) group or a salt thereof.

In the case that X (of Structure R) is a salt, the cation can be: Na⁺, K⁺, Cs⁺, or NH₄⁺.

A violet dichroic dye compound has structure Vc (shown below):

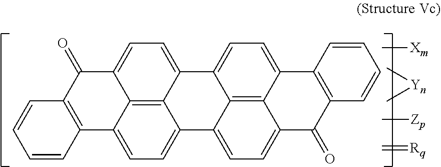

wherein:
X is a SO₃H (sulfonic) group or a salt thereof, and 1≤m≤4;
Y is a S(═O)₂ (sulfone) group, and 0≤n≤2;
Z is a OH (hydroxy) group, and 0≤p≤4;
R is an O (oxo) group, and 0≤q≤4; and
m+p+q≤6.

In the case that X (of structure Vc) is a salt, the cation can be: Na⁺, K⁺, Cs⁺, or NH₄⁺.

Another violet dichroic dye compound has a structure Va (shown below):

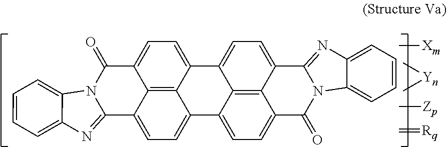

or a cis-isomer of structure Va,

wherein:
X is a SO₃H (sulfonic) group or a salt thereof, and 1≤m≤4;
Y is a S(═O)₂ (sulfone) group, and 0≤n≤2;
Z is a OH (hydroxy) group, and 0≤p≤4;
R is an O (oxo) group, and 0≤q≤4; and
m+p+q≤6.

In the case that X (of structure Va) is a salt, the cation can be: Na⁺, K⁺, Cs⁺, or NH₄⁺.

Useful lyotropic liquid crystal formulations include the red dichroic dye compounds of structure R, the blue dichroic dye compounds of structure B, and violet dichroic dye compounds of structure Vc or Va. This lyotropic liquid crystal formulation may have the blue:violet:red compounds present in a solids weight ratio of 100:35-45:40-50.

The dichroic dye compounds, described herein, form a lyotropic liquid crystal phase when dissolved in a useful solvent, such as water. The dichroic dye compounds may be present in the solution in a concentration range in which a lyotropic liquid crystal is formed. The dichroic dye compounds may be present in water in an amount of about 12 wt %.

The lyotropic liquid crystal solution is shear-coated onto a substrate and dried to form the birefringent coating layer. After the shear-coating step, the coated solution is dried to remove the solvent (such as water) and form a birefringent coating layer.

Lyotropic Liquid Crystals—Retarder Compounds

The lyotropic liquid crystal formulations used herein to make a quarter-wave retarder include a polyphenyl compound, an aromatic heterocycle compound, and a polyaramide polymer, as described herein.

A polyphenyl compound has a structure S1 (shown below):

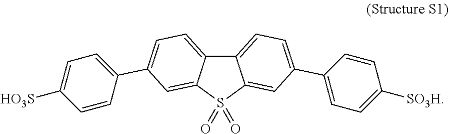 [SMILES: O=S(=O)(O)c1ccc(-c2ccc3c(c2)S(=O)(=O)c2cc(-c4ccc(S(=O)(=O)O)cc4)ccc2-3)cc1]

An aromatic heterocycle compound has a structure S2 (shown below):

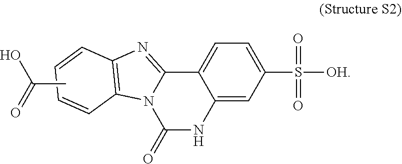

A polyaramide polymer has a structure P2 (shown below):

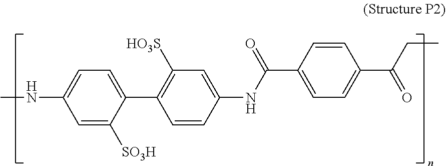

or a Cs salt form of the polyaramide polymer of structure P2.

The polyphenyl compound, the polyaramide polymer, and the aromatic heterocycle, described herein, form a lyotropic liquid crystal phase when dissolved in a useful solvent, such as water. These compounds may be present in the solution in a concentration range in which a lyotropic liquid crystal is formed. These compounds may be present in water in an amount of about 14 wt %.

Birefringent Aromatic Polymer

The polymeric lyotropic liquid crystal solution or multi-component lyotropic liquid crystal solution includes a birefringent aromatic polymer. Birefringent aromatic polymers capable of forming a lyotropic liquid crystal in aqueous solution are used. The birefringent aromatic polymers can include, for example, copolymers and block copolymers. The concentration of the birefringent aromatic polymer in solution should be high enough that a liquid crystal phase is obtained. However, the concentration of the birefringent aromatic polymer should be low enough that the viscosity of the lyotropic liquid crystal solution is suitable for coating.

A birefringent aromatic polymer can be of structure P1 (shown below):

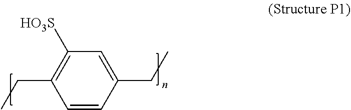

or an alkali metal, ammonium, or quaternary ammonium salt thereof, wherein the number (n) of segments of structure (P1) in the birefringent aromatic polymer ranges from 25 to 10,000. This birefringent aromatic polymer of structure (P1) is referred to as poly(monosulfo-p-xylene). Examples of alkali metals for alkali metal salts of structure (P1) are Na, K, and Cs.

A birefringent aromatic polymer can be of a structure P2 (shown below):

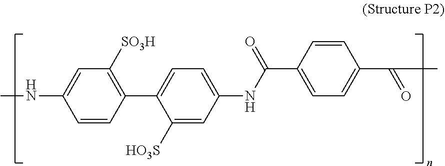

or an alkali metal, ammonium, or quaternary ammonium salt thereof, wherein the number (n) of segments of structure (P2) in the aromatic polymer ranges from 20 to 20,000. This birefringent aromatic polymer of structure (P2) is referred to as poly(2,2′-disulfo-4,4′-benzidine terephthalamide).

Doping-Passivation Solution

Both iodine and an iodide salt are needed in the doping-passivation solution of the Third Embodiment. In the case of KI as the iodide salt, the weight ratio of KI to iodine (I₂) can range between 2:1 and 20:1. Example 19 shows the case where the weight ratio of KI:iodine:water is 10:1:100. If using Sr²⁺ as the multi-valent cations, the cations can be obtained by dissolving SrCl₂ in water. Example 19 shows the case where the weight ratio of SrCl₂:water is 10:100. More generally, the weight ratio of SrCl₂:water can vary between 1:100 and 20:100. If using Al³⁺ as the multi-valent cations, the cations can be obtained by dissolving AlCl₃ in water. The weight ratio of AlCl₃:water can vary between 1:100 and 20:100. Water can be used as the sole solvent of the doping-passivation solution. Other examples of possible solvents are: methanol, ethanol, propanol, butanol, acetone, methyl ethyl ketone, ethyl methyl ether, and diethyl ether. Alternatively, a mixture can be used as a solvent. For example, a water : ethanol mixture can be used as the solvent, with the water:ethanol ratio ranging between 50:50 and 100:0.

Multi-Component Lyotropic Liquid Crystal Solution

The multi-component lyotropic liquid crystal solution, of the second embodiment, contains carbamide, iodide salt, and a birefringent aromatic polymer. In the case of KI as the iodide salt and the Example 17 Polymer as the birefringent aromatic polymer, the weight ratio of KI:Example 17 Polymer can range between 1:2 and 1:10. Example 20 shows the case where the weight ratio of KI:Example 17 polymer is 1:5. Optionally, iodine (I₂) can be added to the multi-component lyotropic liquid crystal solution. In this case, the weight ratio of iodine (I₂):KI can range between 1:10 and 1:5.

Various embodiments of the present disclosure are illustrated by the following examples. It is to be understood that the particular examples, materials, amounts, and procedures are to be interpreted broadly in accordance with the scope and spirit of the disclosure as set forth herein.

### EXAMPLES

All reagents, starting materials and solvents used in the following examples were purchased from commercial suppliers (such as Sigma-Aldrich Corporation, St. Louis, Mo.) and were used without further purification unless otherwise indicated.

Unless otherwise indicated, all percentages indicate weight per cents.

### Example 1

### Blue Dichroic Dye Compound of Structure B

20 g of Indanthrone was added to a mixture of 40 ml Fuming Sulfuric Acid 20% SO₃ and 60 ml Chlorosulfonic Acid, well agitated, heated to 40-55 degrees Celsius and kept at temperature for 3 days. Then the resulted reaction mass was quenched with water and ice, neutralized with 28-30% Ammonium hydroxide and ultrafiltered to remove ammonium sulfate. The retentate was microfiltered and concentrated. Yield 25 g on solid basis. The resulting product was a compound of structure B (below)

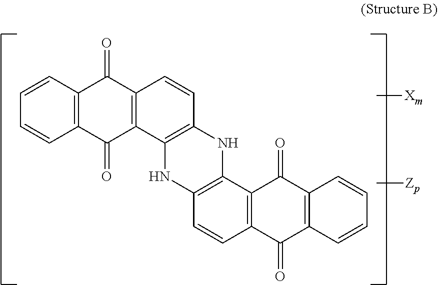

wherein, X is ammonium sulfonate, and 1≤m≤4; Z is Cl (chloro) group, and 0≤p≤2; and
m+p≤4.

### Example 2

### Red Dichroic Dye Compound of Structure R

150 g of pure starting material was prepared by crystallization of commercially available Vat Red 15 from concentrated Sulfuric acid. This material was mixed with 450 ml of Fuming Sulfuric Acid 20% SO₃, heated to 36-46 degrees Celsius and kept at temperature for 3 hrs. The reaction mass was quenched with water and Ammonium Hydroxide, the resulted precipitate was isolated, dissolved in water and ultrafiltered. The retentate was microfiltered and concentrated. Yield 180 g on solid basis. The resulting product was a compound of structure R:

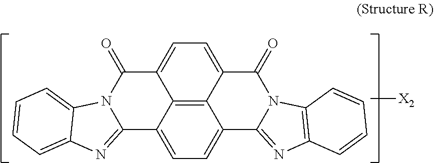

wherein, X is ammonium sulfonate. The trans-isomer of structure R, wherein X is ammonium sulfonate, was also produced.

### Example 3

### Violet Dichroic Dye Compound of Structure Vc

3.25 g of Isoviolanthrone (TCI America) was mixed with 36 ml Fuming Sulfuric Acid 30% SO₃ and agitated overnight. Then the reaction mass was fortified by addition of 47 ml Fuming Sulfuric Acid 65% SO₃ and heated to 75-80 degrees Celsius. The reaction time at temperature was 7 hrs. Then the reaction mass was quenched with water, neutralized with Ammonium Hydroxide and ultrafiltered to remove inorganic salts. The retentate was microfiltered and concentrated. Yield 1.7 g on solid basis. The resulting product was a compound of structure Vc:

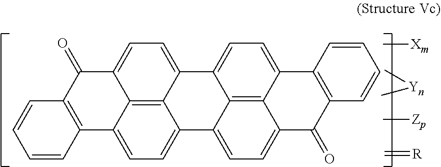

wherein:
X is an ammonium sulfonate, and 1≤m≤4;
Y is a S(═O)₂ (sulfone) group, and 0≤n≤2;
Z is a OH (hydroxy) group, and 0≤p≤4;
R is an O (oxo) group, and 0≤q≤4; and
m+p+q≤6.

### Example 4

### Violet Dichroic Dye Compound of Structure Va

2 g of Pigment Black (BASF) was mixed with 8 ml Fuming Sulfuric Acid 30% SO₃ and agitated overnight. Then the acid was fortified by addition of 6 ml Fuming Sulfuric Acid 65% SO₃ and heated to 61-65 degrees Celsius. The reaction time at temperature was 8 hrs. Then the reaction mass was quenched with water, neutralized with Ammonium Hydroxide and ultrafiltered to remove inorganic salts. The retentate was microfiltered and concentrated. Yield 2.2 g on solid basis. The resulting product was a compound of structure Va:

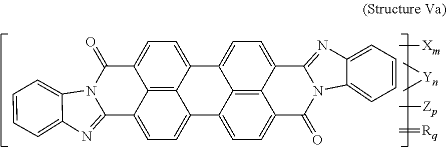

wherein:
X is an ammonium sulfonate, and 1≤m≤4;
Y is a S(═O)₂ (sulfone) group, and 0≤n≤2;
Z is a OH (hydroxy) group, and 0≤p≤4;
R is an 0 (oxo) group, and 0≤q≤4; and
m+p+q≤6.

### Example 5

### Polyphenyl Compound of Structure S1

A 4,4′-(5,5-Dioxidodibenzo[b,d]thiene-3,7-diyl)dibenzenesulfonic acid was prepared by sulfonation of 1,1′:4′,1″:4″,1′″-quaterphenyl. 1,1′.4′,1″.4″,1′″-quaterphenyl (10 g) was charged into 0%-20% oleum (100 ml). Reaction mass was agitated for 5 hours at heating or at ambient conditions. After that the reaction mixture was diluted with water (170 ml). The precipitate was filtered and rinsed with glacial acetic acid (˜200 ml) The filter cake was dried in an oven at about 110° C. Dry 4,4′-(5,5-Dioxidodibenzo[b,d]thiene-3,7-diyl)dibenzenesulfonic acid was added to water and neutralized with 10% CsOH to pH=6.5-7. Yield on dry basis was 10 g. The resulting product was the compound, 4,4′-(5,5-dioxidodibenzo[b,d]thiene-3,7-diyl)dibenzenesulfonic acid:Cs salt, or the Cs salt of the compound of structure S1:

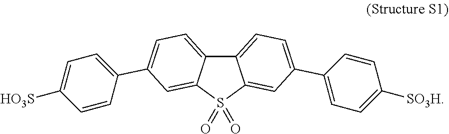 [SMILES: O=S(=O)(O)c1ccc(-c2ccc3c(c2)S(=O)(=O)c2cc(-c4ccc(S(=O)(=O)O)cc4)ccc2-3)cc1]

### Example 6

### Aromatic Heterocycle Compound of Structure S2

100 g of 3,4-Diaminobenzoic Acid was added to a mixture of 63 g of 37% HCl and 2 kg of water and resulting solution clarified through 1 um glass fiber filter. 100 grams of Isatin was added to a mixture of 1.2 kg 37% HCl and 520 g water. The solution of 3,4-Diaminobenzoic Acid was added to the suspension of Isatin and stirred 10 min at 20-25° C. 72 g of 30% Hydrogen Peroxide was added, the resulting mixture heated to 55° C. over 15 min, and the reaction temperature of 55-60° C. maintained for 30 min. The product of the chemical reaction was filtered and washed with 15 kg of 95° C. water. Additionally, the material was purified with 40% Acetic acid and water and dried at 100-105° C. 130 g of dry 6-oxo-5,6-dihydrobenzimidazo [1,2-c] quinozaline-9(10)-carboxylic acid was obtained.

100 g of dry 6-oxo-5,6-dihydrobenzimidazo [1,2-c] quinozaline-9(10)-carboxylic acid was sulfonated using 500 ml 20% Fuming Sulfuric Acid at 50° C. for 3 hrs. After cooling to 20-30° C. the reaction mass was quenched with 590 ml of 91% Sulfuric acid and 1000 ml water and the precipitated product was isolated by filtration. The excessive sulfuric acid was removed by washing the product by small portions of cold water. The wet cake was then neutralized with a solution of Cesium Hydroxide to pH=6.5-7 and the solution concentrated to 35-40%. Yield on dry basis 135 g. The resulting product was 2-sulfo-6,7-dihydrobenzimidazo[1,2-c]quinazoline-6-one-9(10)-carboxylic acid, Cs salt, or the Cs salt of the following:

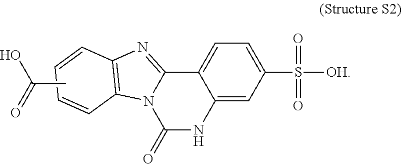

HPLC analysis shows 2 peaks ˜50%/50% of 2 isomers corresponding to carboxy groups in either 9 or 10 position of 2-sulfo-6-oxo-5,6-dihydrobenzimidazo [1,2-c] quinozaline-9(10)-carboxylic acid.

### Example 7

### Birefringent Aromatic Polymer of Structure P2:Cs Salt

10.0 g (0.029 mol) of 4,4′-Diaminobiphenyl-2,2′-disulfonic acid was mixed with 3.1 g (0.029 mol) of Cesium Carbonate and 700 ml of water and stirred till dissolution. While stirring the obtained solution a solution of 6.5 g (0.032 mol) of Terephthaloyl Chloride and 0.3 g of benzoyl Chloride in 700 ml of Toluene was added followed by a solution of 6.1 g of Cesium Carbonate in 100 g of water. The stirring was continued for 3 hours. Then the emulsion was heated to boiling and Toluene distilled out. The resulting water solution was ultrafiltered using PES membrane with MW cut-off 20K Dalton. The solution was concentrated to 6% and liquid crystal phase separated from isotrope. Yield of the polymer was 90 g of 7-8% water solution. Estimated molecular weight Mn is in the range of 50,000 to 100,000. The resulting product was poly(2,2′-disulfo-4,4′-benzidine terephthalamide):Cs salt, or the Cs salt of the compound of structure P2:

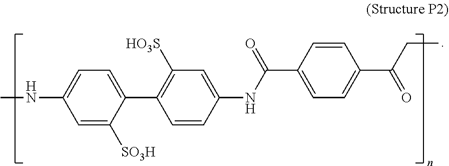

### Example 8

### Linear Polarizer Formulation

This Example 8 shows a lyotropic liquid crystal solution for forming a linear polarizer. Dichroic dye compounds Blue (Structure B) (Example 1), Red (Structure R and its trans-isomer) (Example 2), and Violet (Structure Va and its cis-isomer) (Example 4) are mixed in a certain ratio that defines the spectral performance of the coating. In order to ensure mixing of the components on molecular level the total concentration of the initial mixture is less than 2% solids so that all components are in an isotropic state. In this example, the target was to prepare 100 mL of the formulation containing B, Va (including its cis-isomer) and R (including its trans-isomer) components in the solid to solid ratio of 18:7:8, and a target solids content of 12%. First, we mixed 131 mL of the 5% aqueous solution of Structure B, 51 mL of the 5% aqueous solution of Structure Va (including its cis-isomer), 58 mL of the 5% aqueous solution of Structure R (including its trans-isomer), and added 400 mL of water. Resulting solids concentration was approximately 1.9% by weight.

Then the mixture is filtered through a 0.45 micrometer nylon filter and concentrated to 12% solids by weight using any available method including but not limited to rotary evaporating machines or an ultrafiltration setup. The final mixture is filtered once again through a 0.45 micrometer nylon filter.

### Example 9

### Retarder Formulation

This Example 9 shows a lyotropic liquid crystal solution for forming a retarder. A polyphenyl compound (Structure S1) (Example 5), an aromatic heterocycle compound (Structure S2) (Example 6), and a birefringent aromatic polymer (Structure P2) (Example 7) are mixed in a certain ratio that defines the retardation properties of the coating. In this Example, the components were mixed according to the following ratio S1:P:S2=79:16:5 by weight. The total solids content (S1+S2+P) in aqueous solution was 14%.

### Example 10

### Preparation of Coatable Substrate (First Embodiment)

A coatable substrate according to the first embodiment was prepared as follows. A PET film substrate (38 μm or 125 μm thick) was obtained from NAN-YA PLASTICS Co. of Taipei, Taiwan and was used as the temporary substrate. A release layer material was obtained from ZACROS Co. of TOKYO, JAPAN. A release layer, approximately 400 nm to 500 nm thick, was coated on the PET film substrate. A hydrophilic coating material was obtained from ZACROS Co. of TOKYO, JAPAN. A hydrophilic layer, approximately 30 nm to 100 nm thick, was coated on the release layer. The resulting stack structure was: hydrophilic layer/release layer/PET.

### Example 11

### Preparation of Permanent Substrate for Linear Polarizer

A permanent substrate for a linear polarizer laminate was prepared as follows. An optically clear adhesive (OCA) film including a 10 μm thick OCA layer in between two release films was obtained from ZACROS Co. of TOKYO, JAPAN. A first release film was removed from the OCA layer and a 180 μm thick polycarbonate (PC) substrate, obtained from JIN-TAIWAN Co. of Tainan, TAIWAN was laminated to the OCA layer. The PC substrate is an example of a main substrate. The resulting stack structure was: PC (180 μm)/OCA (10 μm)/second release film.

The second release film is then removed before the OCA layer is adhered to the birefringent coating layer.

### Example 12

### Preparation of Permanent Substrate for Retarder

A permanent substrate for a retarder was prepared as follows. An optically clear adhesive (OCA) film including a 10 μm thick OCA layer in between two release films was obtained from ZACROS Co. of TOKYO, JAPAN. A first release film was removed from the OCA layer and a 33 μm thick stretched cyclic olefin polymer (COP) substrate, obtained from ZEON Co. of TOKYO, JAPAN was laminated to the OCA layer. The stretched COP substrate is a half-wave retarder, and is an example of a main substrate. The resulting stack structure was: COP (33 μm)/OCA (10 μm)/second release film.

The second release film is then removed before the OCA layer is adhered to the birefringent coating layer.

### Example 13

### Forming a Linear Polarizer Laminate (First Embodiment)

A laminate (optical article) including a birefringent coating layer (linear polarizer layer) in accordance with the first embodiment was prepared as follows. The lyotropic liquid crystal formulation from Example 8 was coated on a coatable substrate (Example 10) to a wet thickness of approximately 3 to 6 μm using a slot-die roll-to-roll coater with a coating speed of 1 to 10 meters/min. The lyotropic liquid crystal solution coating on the substrate was dried around 100° C. resulting in a birefringent coating layer (dried layer) of approximately 360 to 720 nm in thickness on the coatable substrate. The resulting stack structure was as follows: birefringent coating layer (linear polarizer layer)/hydrophilic layer/release layer/PET substrate.

The permanent substrate from Example 11 was laminated to the stack with the OCA layer coming into contact with the birefringent coating layer. Then the PET substrate was peeled off from the laminate at the release layer to expose the hydrophilic layer. The resulting stack structure of the laminate was: PC (180 μm)/OCA (10 μm)/birefringent coating layer (linear polarizer layer)/hydrophilic layer.

### Example 14

### Forming a Linear Polarizer Laminate (Second Embodiment)

A laminate (optical article) including a birefringent coating layer (linear polarizer layer) in accordance with the second embodiment was prepared as follows. First a primed PET film substrate (50 μm thick) was obtained from NAN-YA PLASTICS Co. of Taipei, Taiwan. The primed PET substrate already includes a primer layer. The primed PET substrate is referred to as the coatable substrate. The lyotropic liquid crystal formulation from Example 8 was coated on the coatable substrate on the primer layer side to a wet thickness of approximately 3 to 6 μm using a slot-die roll-to-roll coater with a coating speed of 1 to 10 meters/min. The lyotropic liquid crystal solution coating on the substrate was dried around 100° C. resulting in a birefringent coating layer (dried layer) of approximately 360 to 720 nm in thickness on the coatable substrate. The resulting stack structure was as follows: birefringent coating layer (linear polarizer layer)/primer layer/PET substrate.

The permanent substrate from Example 11 was laminated to the stack with the OCA layer coming into contact with the birefringent coating layer. This was done using a heating roller of a lamination machine, as shown schematically in FIG. 12. A heating roller of a lamination machine, maintained at a temperature between 50° C. and 80° C., was brought into contact to the PET substrate side, during lamination of the permanent substrate to the birefringent coating layer with a lamination speed of 0.5 to 2.0 meters/minute. The heat from the heating roller reduced the adhesion of the birefringent coating layer to the PET substrate. Then the PET substrate was peeled off from the laminate at the primer layer. The resulting stack structure of the laminate was: PC (180 μm)/OCA (10 μm)/birefringent coating layer (linear polarizer layer)/primer layer.

### Example 15

### Forming a Retarder Laminate (First Embodiment)

A laminate (optical article) including a birefringent coating layer (retarder layer) in accordance with the first embodiment was prepared as follows. The lyotropic liquid crystal formulation from Example 9 was coated on a coatable substrate (Example 10) to a wet thickness of approximately 8.33 to 10.0 μm using a slot-die roll-to-roll coater with a coating speed of 1 to 10 meters/min. The lyotropic liquid crystal solution coating on the substrate was dried around 100° C. resulting in a birefringent coating layer (dried layer) of approximately 1000 to 1200 nm in thickness on the coatable substrate. The resulting stack structure was as follows: birefringent coating layer (retarder layer)/hydrophilic layer/release layer/PET substrate.

The permanent substrate from Example 12 was laminated to the stack with the OCA layer coming into contact with the birefringent coating layer. Then the PET substrate was peeled off from the laminate at the release layer to expose the hydrophilic layer. The resulting stack structure of the laminate was: COP (33 μm)/OCA (10 μm)/birefringent coating layer (retarder layer)/hydrophilic layer.

### Example 16

### Forming a Retarder Laminate (Second Embodiment)

A laminate (optical article) including a birefringent coating layer (retarder layer) in accordance with the second embodiment was prepared as follows. First a primed PET film substrate (50 μm thick) was obtained from NAN-YA PLASTICS Co. of Taipei, Taiwan. The primed PET substrate already includes a primer layer. The primed PET substrate is referred to as the coatable substrate. The lyotropic liquid crystal formulation from Example 9 was coated on the coatable substrate on the primer layer side to a wet thickness of approximately 8.33 to 10.0 μm using a slot-die roll-to-roll coater with a coating speed of 1 to 10 meters/min. The lyotropic liquid crystal solution coating on the substrate was dried around 100° C. resulting in a birefringent coating layer (dried layer) of approximately 1000 to 1200 nm in thickness on the coatable substrate. The resulting stack structure was as follows: birefringent coating layer (retarder layer)/primer layer/PET substrate.

The permanent substrate from Example 12 was laminated to the stack with the OCA layer coming into contact with the birefringent coating layer. This was done using a heating roller of a lamination machine, as shown schematically in FIG. 12. A heating roller of a lamination machine, maintained at a temperature between 50° C. and 80° C., was brought into contact to the PET substrate side, during lamination of the permanent substrate to the birefringent coating layer with a lamination speed of 0.5 to 2.0 meters/minute. The heat from the heating roller reduced the adhesion of the birefringent coating layer to the PET substrate. Then the PET substrate was peeled off from the laminate at the primer layer. The resulting stack structure of the laminate was: COP (33 μm)/OCA (10 μm)/birefringent coating layer (retarder layer)/primer layer.

### Example 17

### Birefringent Aromatic Polymer (Structure P1)

In this Example 17, synthesis of a birefringent aromatic polymer of structure (P1), sodium salt, or poly(monosulfo-p-xylene), sodium salt, is described. The reaction scheme is as follows:

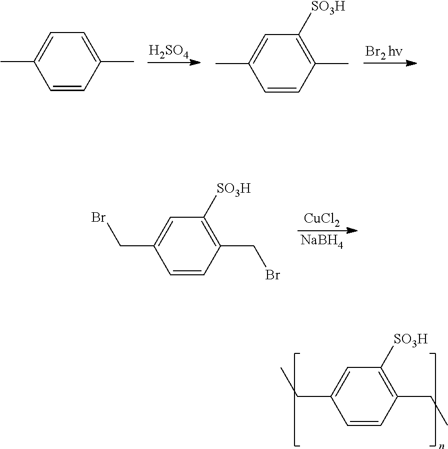

300 ml of sulfuric acid was added to 212 g of p-xylene at 90° C. The reaction mass was stirred at 90-100° C. for 30 min then cooled to 20-25° C. and poured into a beaker with 500 g of mixture of water and ice. The resulting suspension was separated by filtration and the filter cake rinsed with cool (5° C.) solution of 300 ml of hydrochloric acid in 150 ml of water.

The material was vacuum dried at 50 mbar and 50° C. for 24 hrs. Yield of 2,5-dimethylbenzene-sulfonic acid was 383 g (contained 15% water).

92.6 g of 2,5-dimethylbenzene¬sulfonic acid was added to 1700 ml of chloroform and the mixture was purged with argon gas. Then it was heated to boiling with a 500 W lamp placed right against the reaction flask so that stirred contents of the flask was well lit. 41 ml bromine in 210 ml of chloroform was added dropwise within 4-5 hrs to the agitated boiling mixture. Once all bromine had been added the light exposure with refluxing continued for an extra hour. 900 ml of chloroform was distilled and the reaction mass was allowed to cool overnight. Precipitated material was isolated by filtration, the filter cake was rinsed with 100 ml of chloroform, squeezed and recrystallized from 80 ml of acetonitrile. Yield of 2,5-bis(bromomethyl)benzenesulfonic acid was 21 g.

4.0 g of sodium borohydride in 20 ml of water was added to a stirred mixture of 340 mg of CuCl₂, 10.0 g of 2,5-bis(bromomethyl)benzenesulfonic acid, 10.4 g of sodium bromide, 45 ml of amyl alcohol and 160 ml of degassed water and the reaction mass was agitated for 10 min. Then the mixture was transferred to a 1-liter separatory funnel, 300 ml of water was added and after shaking the mixture was allowed to stand for an hour. The bottom layer was isolated, clarified by filtration and ultrafiltered using a polysulfone membrane with 10,000 molecular weight cut-off. Yield of birefringent aromatic polymer of structure P1, Na salt is 4.0 g (on dry basis).

### Example 18

### Birefringent Aromatic Polymer (Structure P2, Na Salt)

In this Example 18, synthesis of a birefringent aromatic polymer of structure (P2), sodium salt, or poly(2,2′-disulfo-4,4′-benzidine terephthalamide), sodium salt, is described. The reaction scheme is as follows:

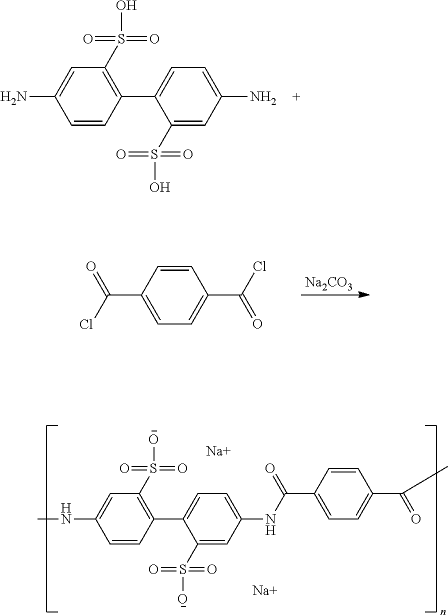

10.0 g (0.029 mol) of 4,4′-Diaminobiphenyl-2,2′-disulfonic acid was mixed with 3.1 g (0.029 mol) of Sodium Carbonate and 700 ml of water and stirred till dissolution. While stirring the obtained solution a solution of 6.5 g (0.032 mol) of Terephthaloyl Chloride in 700 ml of Toluene was added followed by a solution of 6.1 g of Sodium Carbonate in 100 g of water. The stirring was continued for 3 hours. Then the emulsion was heated to boiling and Toluene distilled out. The resulting water solution was ultrafiltered using PES membrane with MW cut-off 20K Dalton. Yield of the polymer was 180 g of 8% water solution.

Gel permeation chromatography (GPC) analysis of the sample was performed with Hewlett Packard 1260 chromatograph with diode array detector (λ=230 nm), using Varian GPC software Cirrus 3.2 and TOSOH Bioscience TSKgel G5000 PW_{XL}column and 0.2 M phosphate buffer (pH=7) as the mobile phase. Poly(para-styrenesulfonic acid) sodium salt was used as GPC standard. The calculated number average molecular weight Mn, weight average molecular weight Mw, and polydispersity PD were found as 1.1×10⁵, 4.6×10⁵, and 4.2 respectively.

### Example 19

### Coated Sample Preparation and Measurements (Third Embodiment)

Details of the procedures for preparing coated samples according to the third embodiment are given in this Example 19. A TAC film (80 μm thick) is used as the coatable substrate. The coatable substrate is prepared by coating with a primer solution to improve adhesion of the coating. In this case, the primer solution is (3-Aminopropyl)trimethoxysilane, abbreviated APTMS, diluted to 1% in water. The primer solution is filtered through a 0.45 μm Nylon membrane filter before coating. The primer solution is coated on the coatable substrate using a Mayer rod #2. The designation #2 refers to the diameter of the wire on the Mayer rod in mils. The coatable substrate is then dried in an oven at 60° C. for 5 minutes, and is now ready for coating with the polymeric lyotropic liquid crystal solution.

A polymeric lyotropic liquid crystal solution is prepared by dissolving the Example 17 polymer in water at a concentration of 16%. The polymeric solution is coated on the coatable substrate using Mayer rod #4, and the resulting coated substrate is dried in an oven at 60° C. for 5 minutes. Thickness of the resulting polymeric birefringent coating layer is approximately 0.8 μm.

The doping-passivation solution is a solution containing doping and passivation constituents. The doping constituents are iodine (I₂) and iodide salts. In this case, the iodide salt is KI and the passivation constituent is SrCl₂. The doping-passivation solution is prepared as follows. Iodine (1 weight part) and KI (10 weight parts) are mixed and dissolved in 100 weight parts of water. The mixture is stirred for 10 minutes with no heating. The passivation constituent, SrCl₂ (10 weight parts), is added and mixed for 30 minutes with no heating.

The coated substrate is dipped in the doping-passivation solution for 90 seconds. The coated substrate is then dipped in a rinse solution for 3 seconds. In this case, the rinse solution is ethanol. Excess liquid is blown off of the coated substrate using compressed air. The coated substrate is dried in an oven at 60° C. for 5 minutes.

Optical measurements conducted on the Example 19 sample are reported in FIGS. 24 and 25.

### Example 20

### Coated Sample Preparation and Measurements (Fourth Embodiment)

Details of the procedures for preparing coated samples according to the fourth embodiment are given in this Example 20. A multi-component lyotropic liquid crystal solution is prepared by dissolving carbamide (4 weight parts), KI (2.4 weight parts), and the Example 1 polymer (12 weight parts) in water (100 weight parts). A TAC film (80 μm thick) is used as the coatable substrate. The coatable substrate is prepared as in Example 19.

The multi-component lyotropic liquid crystal solution is coated on the coatable substrate using Mayer rod #8, and the resulting coated substrate is dried in an oven at 60° C. for 5 minutes. Thickness of the resulting multi-component birefringent coating layer is approximately 1.5 μm. The coated substrate is treated with a corona treater for 60 seconds.

Optical measurements conducted on the Example 4 sample are reported in FIGS. 26 and 27. The optical measurement results explained with reference to FIGS. 23-27 were performed using Shimadzu UV-2600 spectrophotometer equipped with a Glan polarizer in the signal beam. The spectrophotometer measured Tₚₑᵣ and Tₚₐᵣₐ, and TT, PE, and Kd values were calculated therefrom.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure and claims. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

What is claimed is:

1. A method of forming an optical article, comprising the steps of:
providing a lyotropic liquid crystal solution;
providing a coatable substrate comprising a temporary substrate and a surface modification layer;
shear-coating the lyotropic liquid crystal solution on the surface modification layer to form a birefringent coating layer on the surface modification layer, the birefringent coating layer being 4 micrometers or less in thickness, the birefringent coating layer having a first major surface in contact with the surface modification layer and a second major surface opposite the first major surface;
providing a permanent substrate comprising a main substrate and an adhesive layer;
laminating the permanent substrate to the birefringent coating layer such that the adhesive layer is adhered to the second major surface; and
separating the temporary substrate from the birefringent coating layer such that the coating layer remains adhered to the adhesive layer.

2. The method of claim 1, wherein:
the step of providing the coatable substrate additionally comprises applying a release layer between the temporary substrate and the surface modification layer; and
the release layer is separated from the birefringent coating layer during the step of separating the temporary substrate from the birefringent coating layer.

3. The method of claim 1, wherein:
the step of providing the permanent substrate comprises the steps of:
providing an adhesive film comprising a first release film, a second release film, and the adhesive layer between the first and second release films, the adhesive layer having a third major surface in contact with the first release film and fourth major surface opposite the adhesive layer first major surface in contact with the second release film;
removing the first release film from the adhesive layer;
laminating the main substrate to the third major surface; and
removing the second release film from the adhesive layer.

4. The method of claim 1, additionally comprising:
contacting a heating roller to the temporary substrate, before the step of separating the temporary substrate from the birefringent coating layer.

5. The method of claim 1, wherein the birefringent coating layer is 2 micrometers or less in thickness.

6. The method of claim 1, wherein the surface modification layer is selected from the group consisting of: primer layer and hydrophilic layer.

7. The method of claim 1, wherein the adhesive layer comprises an acrylic polymer.

8. The method of claim 1, wherein the birefringent coating layer comprises a birefringent aromatic polymer.

9. The method of claim 1, additionally comprising:
treating the birefringent coating layer with a doping-passivation solution comprising iodine anions and multi-valent cations.

10. The method of claim 1, wherein the birefringent coating layer is selected from the group consisting of: linear polarizer layer and retarder layer.

11. An optical article, comprising:
a birefringent coating layer of 4 micrometers or less in thickness having first major surface and a second major surface opposite the first major surface;
a hydrophilic layer or a primer layer in contact with the first major surface;
a main substrate; and
an adhesive layer between the main substrate and the birefringent coating layer, the adhesive layer having a third major surface and a fourth major surface opposite the third major surface, the third major surface being in contact with the main substrate and the fourth major surface being in contact with the second major surface.

12. The optical article of claim 11, wherein the adhesive layer comprises an acrylic polymer.

13. The optical article of claim 11, wherein the birefringent coating layer is 2 micrometers or less in thickness.

14. The optical article of claim 11, wherein the birefringent coating layer is 1.0 micrometers or less in thickness and comprises a birefringent aromatic polymer, iodine anions, and multi-valent cations.

15. The optical article of claim 11, wherein the birefringent coating layer comprises a birefringent aromatic polymer, and the birefringent aromatic polymer is of a structure P1: 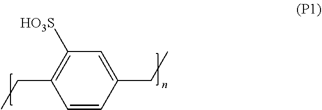
or a salt thereof, wherein n is an integer in a range from 25 to 10,000;
or the birefringent aromatic polymer is of a structure P2: 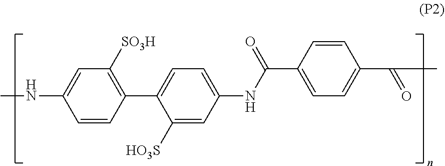
or a salt thereof, wherein n is an integer in a range from 20 to 20,000.

16. The optical article of claim 11, wherein the birefringent coating layer comprises a birefringent aromatic polymer, and the birefringent aromatic polymer comprises a group (SO₃⁻).

17. The optical article of claim 11, wherein the birefringent coating layer is selected from the group consisting of: linear polarizer layer and retarder layer.

18. A circular polarizer comprising the optical article of claim 11.

19. A linear polarizer comprising the optical article of claim 11.

20. A display comprising the optical article of claim 11.
